(19) United States
(12) Patent Application Publication
(10) Pub. No.: US 2004/0216147 A1
(43) Pub. Date: Oct. 28, 2004

(54) Component based application middleware framework

(75) Inventors: John Anthony Yanosy, Grapevine, TX (US); Anthony J. Dennett, Fort Worth, TX (US); Dario Martinez, Fort Worth, TX (US); Herbert Calhoun, Colleyville, TX (US); Marek Andrzej Pietrzyk, Palatine, IL (US); Lewis Benjamin Oberlander, Buffalo Grove, IL (US); Eva Labowicz, Roselle, IL (US); Ganesan Rengaraju, Oak Park, IL (US); Farhan Ahmed Siddique, Lake Villa, IL (US); Mashiro Maeda, Tokyo (JP)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/197,781

(22) Filed: Jul. 18, 2002

(51) Int. Cl. G06F 9/00; G06F 9/46

(52) U.S. Cl. 719/328

(57) ABSTRACT

A component based Application Middleware Framework (20) for modifying Application Middleware Framework (AMF) component services includes an interceptor (70) for intercepting an interface event being transmitted from a software management application (14a-14e) to a software component (40, 42). A rules database (48, 78) stores AMF component service modifying rules, and an adaptor (72) modifies the interface event based on the AMF component service modifying rules stored in the rules database (48, 70). A policy engine (74) attempts to match the interface event with the AMF component service modifying rules stored in the rules database (48, 70), and subsequently coordinates the modification of the AMF component service by the adaptor (72) when the policy engine (74) matches the interface event with at least one of the AMF component service modifying rules stored in the rules database (48, 70).

### RELATED APPLICATIONS

The present application for patent is related to co-pending application Ser. No. 10/128,077 by Yanosy, assigned to the same assignee, and titled Programmatic Universal Policy Based Software Component System for Software Component Framework.

### BACKGROUND OF THE INVENTION

1. Field of the Invention

The present invention relates to software application design and development, and specifically to an extensible Application Middleware Framework that simplifies application development.

2. Description of Related Art

Conventional approaches to component based software development dictate that a software application is created through development, integration, and installation of one or more underlying software components. Each software component, once installed, provides the other software components with the ability to access its functional capability through a well-specified interface, commonly known as an Application Programming Interface (API). The software component receives requests, known as function calls, through this API, and in response provides access to its internal software component operations. The software component responds to function calls according to the programmatic functional behavior associated with the specific function call or calls defined within and supported by its API.

However, such conventional approaches do not provide much programmatic flexibility regarding use of the software components once the components are installed into the application system, as the components typically provide only a single service access API for reuse by other software applications and also conform only to applicable platform or middleware interfaces for compatible runtime operation. Therefore, once the software components are installed or integrated into the system runtime platform, the behavior of the component API cannot be modified or constrained in any manner.

In addition, standard application middleware only provides services to support and manage the software components to facilitate the construction of a distributed software environment in which the software components are able to communicate with one another. In other words, the above discussed conventional software development approaches focus on the components or, in the case of object oriented programming, on the objects, and on the management and communication between the components rather than on the services offered by the components and the associated formal middleware specification. As a result, many common generic services, such as security or quality of service (QOS) services common to most or all of the components must be provided in the software component layer, thereby creating programming redundancies and thus complicating application development.

Therefore, what is needed is an extensible Application Middleware Framework for providing services, preferably common to multiple applications, that are capable of being modified, controlled, or constrained subsequent to framework installation, to thereby simplify overall application design and development.

### BRIEF DESCRIPTION OF THE DRAWINGS

Objects and advantages of the present invention will be more readily apparent from the following detailed description of preferred embodiments thereof when taken together with the accompanying drawings in which:

FIG. 1 is a side cross-sectional view of an exemplary layered software application framework including a component based Application Middleware Framework according to the present invention;

FIG. 2 is a partially exploded perspective view of the layered software application framework of FIG. 1;

FIG. 3 is a detailed block diagram of the component based Application Middleware Framework of FIG. 1;

FIG. 4 is a package structure diagram of exemplary application framework models forming the component based Application Middleware Framework according to the present invention;

FIG. 5 is a more detailed block diagram of an exemplary Application Middleware Framework component according to the present invention; and

FIG. 6 is an exemplary physical environment in which the component based Application Middleware Framework according to the present invention may be advantageously deployed.

### DETAILED DESCRIPTION OF THE PRESENTLY PREFERRED EXEMPLARY EMBODIMENTS

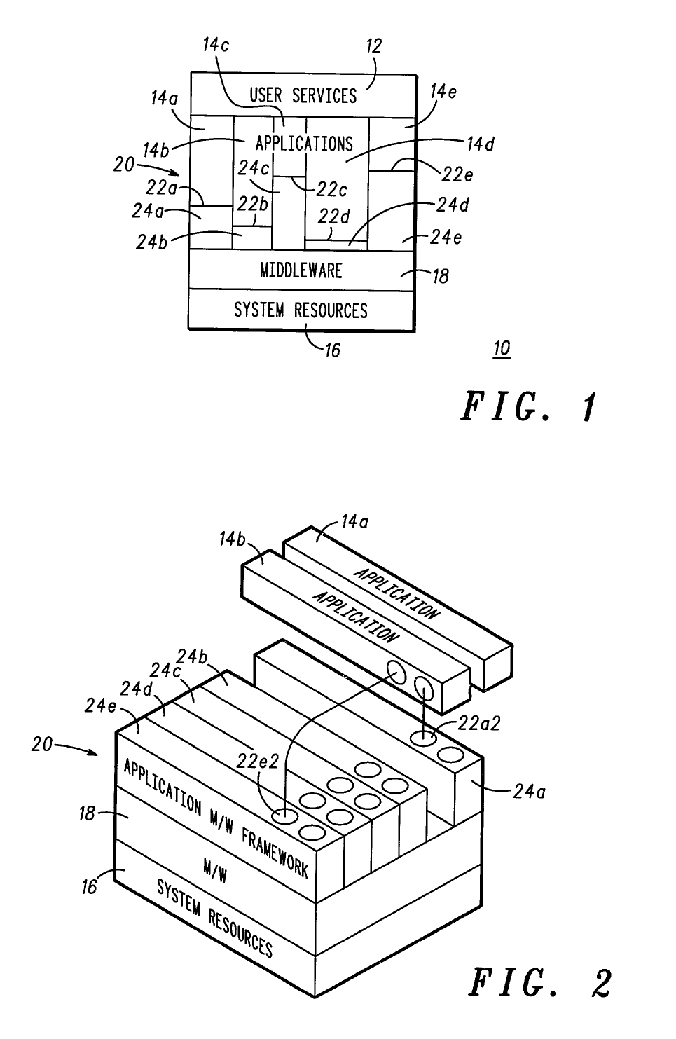

Referring now to the drawings in which like numerals reference like parts, FIG. 1 shows generally the layers of an exemplary software application framework 10. The software application framework 10 includes user services 12 including, for example, mobile communications based electronic enterprise services in a World Wide Web context, realized through a set of software management applications 14a-14e such as, for example, mobile communications based e-commerce applications. The software management applications 14a-14e access system resources 16 that may be, for example, a wireless network infrastructure of local area networks (LANs), cellular communications networks and communications satellites, through conventional and commercially available middleware 18, such as, for example, distributed software middleware such as J2EE, CORBA, DCOM or Parlay. In addition, and according to the present invention, the software management applications 14a-14e also access the system resources 16 through a component based Application Middleware Framework referenced generally at 20 and including generic Application Middleware Framework (AMF) APIs 22a-22e and corresponding AMF components 24a-24e.

As will be discussed in detail below, the component based Application Middleware Framework 20 of the present invention provides an additional layer of abstraction to the conventional middleware 18 to offer services that are common to some or all of the software management applications 14a-14e so that the services need not be separately included in each software application. The component based Application Middleware Framework 20 also enables new middleware services to be added thereto through the definition and addition of new AMF components and corresponding new APIs. For example this facilitates or enables one or more of the extension of the existing AMF components 24a-24e (FIG. 2) through the extension of AMF component services offered at respective AMF APIs 22a-22e, new coordination service aggregations to be added, and the editing of rules associated with a particular AMF component API. As a result, development, design and modification of the software management applications 14a-14e are simplified.

The component based Application Middleware Framework 20 is software programming language and platform independent, as its requirements and design are specified in UML models and repositories. Actual runtime components for different software platforms and for different programming languages can be created from the same UML specifications. Therefore, different platform languages and environments such as, for example, Java, J2EE, VB, DCOM, CORBA and C++, can be supported. The component based Application Middleware Framework 20 is also applicable to any application software platform that runs on distributed software middleware, and to any software application environment in which applications have common services and in which a further level of abstraction is desired, such as the services provided by the AMF components 24a-24e themselves.

FIG. 2 illustrates in exemplary form how software applications such as the software management applications 14a, 14b, and the component based Application Middleware Framework 20 are interconnected. As should be appreciated, the user services 12 are realized from the software management applications 14a-14e, which access the core system resources 16 via a set of the AMF APIs 22a-22e based on the requested type of user service and the corresponding AMF component required to facilitate the access of the system resources 16 by the software management applications 14a, 14b. For example, the software management application 14b is shown as accessing the system resources 16 through an AMF API 22a2 of the AMF component 24a and an AMF API 22e2 of the AMF component 24e. Each software application must conform to the API specification of the Application Middleware Framework 20 when it wants to access services of the Application Middleware Framework 20. In general, each of the AMF APIs 22a-22e within the component based Application Middleware Framework 20 exposes a set of defined and tested capabilities to each of the software management applications 14a-14e through a published unique interface (API) for each of the AMF components 24a-24e.

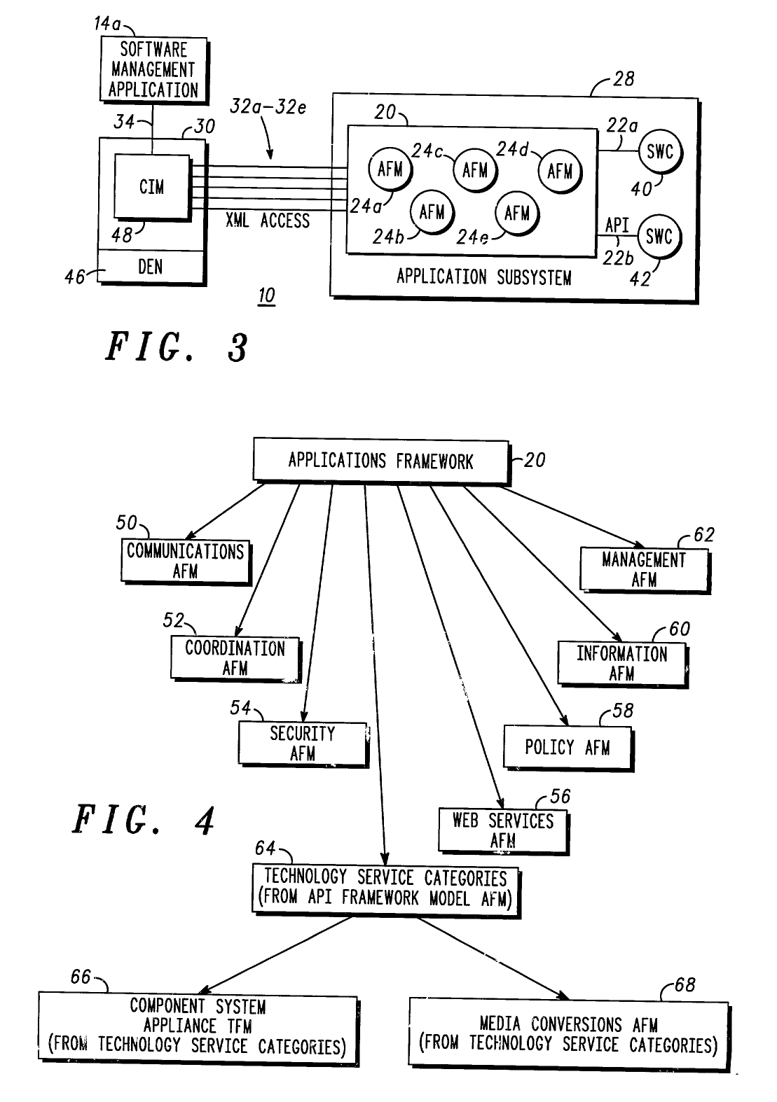

FIG. 3 shows certain exemplary components of the software application framework 10 in greater detail. The software application framework 10 enables each of the software management applications 14a-14e to affect the operational behavior of one or more application subsystems, such as the exemplary application subsystem 28, through communications with an application management server 30, which is also in communication with the application subsystem 28 and the software management applications 14a-14e via application interfaces 32a-32e and 34, respectively.

The application subsystem 28 may contain any application software such as, for example, a software component based product or subsystem, application middleware, or an application development tool, defined by one or more legacy software components, such as exemplary software components 40, 42, which are not policy based, and the services of the component based Application Middleware Framework 20. Regardless of its specific type, the application subsystem 28 is one in which a system integrator or, in the telecommunications area, a service provider, wishes to simplify application design by abstracting various common application services and at the same time maintain the ability to control, constrain, or modify the services offered by the AMF components 24a-24e.

While the application subsystem 28 includes non-policy based software components 40, 42 and the component based Application Middleware Framework 20, its configuration is only exemplary, as other configurations are possible. For example, all software components may be policy-based components similar to the component based Application Middleware Framework 20. Alternatively, any combination of policy based and non-policy based software components may also be used to configure the application subsystem 28 depending upon the particular software application being implemented. In addition, the functional dependencies of the software components 40, 42, with respect to the AMF APIs 22a, 22b, are also exemplary, with other interconnection configurations being possible.

The AMF components 24a-24e provide the application subsystem 28, applications and software components such as the software components 40, 42 with specialized services, and also offer further behavior modification with programmatic policy based functional capabilities by enabling policies in the application server 30 that affect the operational behavior of the component service based Application Middleware Framework 20 in response to function calls, referred to generally as interface events, across one or both of the exemplary AMF APIs 22a, 22b. The exemplary software management application 14a communicates with the application server 30 across the application interface 34 for the purpose of modifying or adding policy rules associated with AMF components 24a-24e, within one or more application subsystems, such as the application subsystem 28. Such a configuration is exemplary only and is not limited to usage of central policy rule storage systems such as the application server 30, but also may be realized using a configuration in which one or more policy rule storage systems could be associated with the platforms hosting distributed elements of the application subsystem 28.

Policy information associated with the AMF components 24a-24e of the component based Application Middleware Framework 20 is accessed from the application server 30 through the application interface 32. The software components, such as the software components 40, 42, and the component based Application Middleware Framework 20 may be programmed in a variety of languages for compatibility with different middleware platforms such as, for example, C, CORBA, Visual BASIC, or JAVA. However, for purposes of the present invention, the software components 40, 42, and the component based Application Middleware Framework 20 may be programmed in any computer language that supports component based software implementations and the services offered by the AMF components 24a-24e. Each application component that requires access to an AMF service must conform to an interface API specification such as the specifications of the AMF APIs 22a, 22b, of a particular AMF. One skilled in the art will appreciate that the software components 40, 42 and the component based Application Middleware Framework 20 may also be software objects or other like elements used to compile and create a software application and that may be re-used by developers for one or more alternative applications.

In FIG. 3, the software components 40, 42 have access to the services, or functions, of the component based Application Middleware Framework 20 through the AMF APIs 22a-22b offered to other components by the component based Application Middleware Framework 20. Though each of the software components 40, 42 includes several subprograms individually defined by a name and selectively activated in response to an interface event, the exemplary configuration of FIG. 3 illustrates the situation where software components 40, 42 can call a service offered by the component based Application Middleware Framework 20 by its name through the AMF APIs 22a, 22b, respectively.

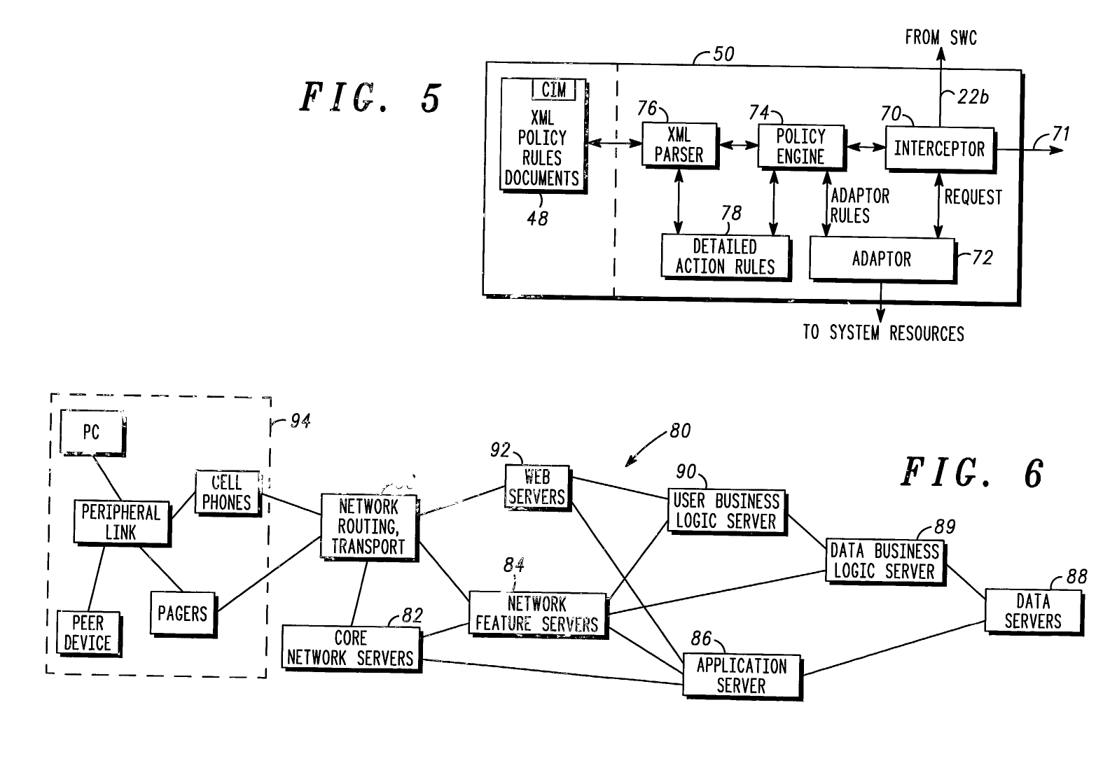

The component based Application Middleware Framework 20 is capable of accessing stored policy rule sets, referred to also as AMF component service modifying rules or rule sets, in the application server 30 through the interface 32 to conditionally modify the behavior of the services of the AMF components 24a-24e when appropriate. However, the component based Application Middleware Framework 20 may also be retrofitted with a set of detailed action based rules 78 (FIG. 5).

The application server 30, also referred to as a policy storage server, includes a directory-enabled network (DEN) 46 that may store XML, RDF or other semantic format type AMF component service modifying documents in a directory mediated by a defined common information model (CIM) 48 (XML formatted component modifying documents will be referred to for purposes of discussion). In other words, the CIM 48, which is preferably realized by any commercial database technology with XML type access, specifies policies that are appropriate for one or more AMF components. The component based Application Middleware Framework 20 is capable of accessing these XML formatted component service modifying documents through the CIM 48 and across the application interface 32 based on, for example, a Lightweight Directory Access Protocol (LDAP). Other protocols for accessing the CIM policy information can be used, consistent with the ability to access and transport the service modifying information to the component based Application Middleware Framework 20.

FIG. 4 illustrates exemplary AMF components of the component based Application Middleware Framework 20. The AMF components corresponding generally to the AMF components 24a-24e in FIG. 1 and forming the Application Middleware Framework 20, are shown in a compositional Unified Modeling Language (UML) structure diagram. Specifically, FIG. 4 identifies the following types of AMF components: a Communications AMF component 50, a Coordination AMF component 52, a Security AMF component 54, a Web Services AMF component 56, a Policy AMF component 58, an Information AMF component 60, and a Management AMF component 62. Each of these AMF components will now be discussed in detail.

The Communications AMF component 50 provides middleware framework services required for the applications 24 to access the system resources 16 via a standard set of APIs such as the AMF APIs 22a-22e. The Communications AMF component 50 provides the framework required to enable application developers to access the wide range of capabilities and services provided by current and future communication networks, and is intended to be the single point in the software application framework 10 where application developers can access the communications APIs needed to access network capabilities and services. The Communications AMF component 50 exposes a full description of these interfaces together with operations and signatures. Any suitable APIs already defined by standards bodies or applicable development groups will be included in the component based Application Middleware Framework 20. The API offered by the Communications AMF component 50 to applications will be generalized and yet extensible, while the Communications AMF component 50 will adapt function calls of a specific type from an application to the interface requirements of the system resources 16 (FIG. 1) associated with the network.

In some situations, the Communications AMF component 50 will be called upon by other AMF components to provide support for services offered by the other AMF components. Since APIs are included in the Parlay middleware, there are some QOS APIs defined that may possibly be used by, for example, a Quality of Service (QOS) framework (not shown). Furthermore, the Communications AMF component 50 will call upon the services of the Policy AMF component 58 regarding communication policy issues, and will be managed by the Management AMF component 62. Also, the Coordination AMF component 52 may call upon the services of the Communications AMF component 50 for heartbeat supervision to respond periodically to confirm that it (the Communications AMF component 50) is properly functioning.

The Communications AMF component 50, like other AMF components in the component based Application Middleware Framework 20, is one of the major service categories that offer services to the software management applications 24a-24e through a self-specified interface. Therefore, the services of any AMF component are always accessible to any application in the software application framework 10, regardless of the particular host device. An application developer can thus develop the software management applications 24a-24e to utilize the Communications AMF component 50 as if it was directly accessible in the same computer as the applications 24a-24e. In this way, communications services can be offered to the software management applications 24a-24e without the need for the services to physically be included in the applications themselves.

The distributed systems standards, such as CORBA, and their implementations, address the issue of configuration of components by introducing a brokering mechanism, which matches requests by components for particular services with components providing these services. With these basic building blocks in place, most configuration issues can be addressed. However, coordination is not addressed in standards, and is left entirely to the programmer of the components, or worse, to the programmer of the applications. In fact, coordination is typically embedded in the application code rather than being separated.

The Coordination AMF component 52 is important because coordination and configuration are central issues in the design and implementation of distributed software applications such as the software management applications 24a-24e in the software application framework 10. Coordination and configuration are primary reasons why the construction of such frameworks is more difficult and complex than that of stand-alone, sequential frameworks. Through configuration, the structure of the framework is established, including framework elements, such as the AMF components of FIG. 1. The Coordination AMF component 52 is concerned with the interaction of the various elements, including when the interaction takes place, which parties are involved, what protocols are followed. Its purpose is to coordinate the behavior, or in other words the service(s), of the components in a way that meets the overall specification of the software application framework 10. The Coordination AMF component 52 will always be involved in any AMF component response because its rules will be interrogated to see if there are any other considerations that need to be accounted for beyond the local rules of an AMF component. The Coordination AMF component 52 will also provide an AMF component with the ability to access other AMF services through its brokering function.

The Security AMF component 54 contains information describing its roles, the services it offers and the particular security problem types facilitated by these services, the influence of different application architectures, the relationship of its security standards to other industry defined security standards, and a recommended set of security services that should be offered, and provides security for communications among all layers of the software application framework 10.

The Security AMF component 54 will provide a set of security services to the applications 14, to other AMF components and to users of the user services 12. The Security AMF component 54 will call upon services provided by the other AMF components to support the provided security services. In particular, security data will be stored and accessed using services provided by the Information AMF component 60, and the Security AMF component 54 will call upon the Policy AMF component 58 with respect to the use of policies.

Security is a policy driven domain, meaning that the operator may establish security policies for a deployed application system. In the software application framework 10, the Information AMF component 60, the Policy AMF component 58 and the Security AMF component 54 are codependent upon each other. The Information AMF component 60 provides directory services based on X.500 or equivalent, principles with its own security services associated with access and authorization levels to the objects and information contained in the directory itself. The Policy AMF component 58 provides the primary control for acting on policy rules in general associated with service requests, or function calls to and within the software application framework 10, including the software management applications 14a-14e, to other AMF components and to users of the user services 12.

In general, the Security AMF component 54 interacts with the Policy AMF component 58 when a service request is made to determine if there are any policy considerations associated with this service request. For example, with respect to inter-AMF component communications, a service provider or framework operator may set policy conditions to enable specific security mechanisms for different types of inter-AMF component communications or requests.

The Policy AMF component 58 receives requests for services from most likely another AMF component and then queries the Information AMF component 60 to determine if there are any policies that constrain this application service request. The Policy AMF component 58 will then respond to the Security AMF component 54 regarding any policy conditions that affect the service request to the Security AMF component 54, either by an application, or by another AMF component.

As will now be discussed, there are multiple scenarios where security services of the Security AMF component 54 may be invoked. For example, these services are invoked when an application directly requests services of the Security AMF component 54 and the Policy AMF component 58 is involved in determining any specific policies with this request. Also, security services are invoked when any AMF component specifically requests security services from the Security AMF component 54 and again the Policy AMF component 58 determines if there are any policy considerations associated with this request.

Further, security services are invoked when an application requests services from an AMF component and a normal query to the Policy AMF component 58 results in a need for security to be applied to this service request and response.

The Web Services AMF component 56 contains basic definitions that enable, for example, a mobile communications subscriber to access the World Wide Web and related services. The Web Services AMF 56 may be programmed to access, for example, commercially available services. The Policy AMF component 58 is the primary means for flexibly controlling the software application framework 10, as it offers a set of services for controlling the set of AMF components as the AMF components react to service requests from the applications 14a-14e. The Policy AMF component 58 includes policy rules such as subscriber-controlled policies, management controlled policies, application policies, context rule policies such as policies for subscription context information, and application API framework service category policies that are stored in the Information AMF component 60.

The Information AMF component 60 provides access services, such as database interfaces (SQL, MS DAO, ODBC), directory services (X.500 and derivatives, NIS, NDS and specialized services such as HLR, VLR or DNS) and directory information tree (DIT) structures to other AMF components and the applications 14a-14e for the types of information necessary for management of the applications 14a-14e and the component based Application Middleware Framework 20. These services are preferably based on X.500 and preferably support XML document types.

The Management AMF component 62 provides all necessary management services to deploy, provision, operate, administer and maintain the software Application Middleware Framework 20. The Management AMF component 62 is also intended to enable holistic management of the software application framework 10 to coordinate the software management applications 14a-14e with the component based Application Middleware Framework 20. The Management AMF component 62 is based upon the CIM 48, and will call upon services provided by the other AMF components to support the provided management services. In particular, management data will be stored and accessed using services provided by the Information AMF component 60, and the Management AMF component 62 will call upon the Policy AMF component 58 with respect to the use of policies.

In addition to the above AMF components, the component based Application Middleware Framework 20 may also optionally include technology service categories 64 that include, for example, an appliance technology framework model (TFM) 66 that provides APIs similar to the AFM APIs 22a-22e in FIG. 1 to enable the applications 14a-14e to access technology based services such as voice recognition services, media storage services, and a media conversion AMF 68 that can convert context to appropriate formats for clients.

FIG. 5 shows a typical configuration of an exemplary AMF component, such as the Communications AMF component 50, of the component based Application Middleware Framework 20. A selector, referred to hereinafter as an interceptor, 70 is for intercepting an interface event such as a function call transmitted from, for example, the software component 42 via an API, such as the AFM API 22b, and also is for informing the software components 40, 42 that the behavior of the AMF component 50 correlated with an intercepted interface event has been adapted/modified/constrained. In addition, the interceptor 70 is for sending and receiving communications to and from other AMF components over an inter-AMF interface 71. An adaptor 72 is for performing any actual adaptation/modification/constraint imposed on the AMF component 50 based on instructions communicated from a policy engine 74, including calling on external services, such as API services of another AMF component or the middleware 18 (FIG. 1) to extend AMF component functionality if so instructed.

In addition to instructing the adaptor 72 as to what actions to take in response to the interface event, the policy engine 74 is also responsible for first processing the interface event by instructing a parser, such as an XML parser, 76 to search policy rules, such as XML policy rules documents, contained in the CIM 48, to determine if any of the stored policy rules match with the interface event (an event match). As shown, these policy rules are documents that are stored externally from the Communications AMF component 50 at the CIM 48; however, the policy rules documents may also be stored in an XML database located in the Communications AMF component 50 itself. The parser 76 is for determining whether an event match exists by searching the respective start and end tags of the stored XML policy rules, as such tags are related to the associated function calls, and for subsequently informing the policy engine 74 of the results of the search.

If the parser 76 determines that a match does exist between at least one stored policy rule and the interface event, it notifies the policy engine 74 of the event match and also transmits details of the event match to the detailed action rules database 78. As with the XML policy rules, the detailed action rules may be located externally from, or within, the Communications AMF component 50, depending upon specific network design parameters. However, for purposes of illustration and discussion, the detailed action rules database 78 is shown as being located within the Communications AMF component 50. The rules located within the detailed action rules database 78 atomically define actions to be taken by the interceptor 70 and the adaptor 72 as a result of the event match. For example, if an XML policy rule defines “For this function call, provide service X,” a corresponding detailed action rule might specifically define service X.

At this point it should be noted that either the XML policy rules or the detailed action rules may be revised in order to revise how the AMF components 50-62, and therefore interface events, are modified/constrained/adapted. Obviously, the software components 40, 42 are also affected by the changes in services offered by the AMF components 50-62. This feature of the component based Application Middleware Framework 20 enables the AMF components 50-62 to be adapted to changing application requirements or to be later re-used in an application wholly or partially unrelated to the original application in which the AMF component is used. Specifically, an AMF component may be modified so that it corresponds to a new set of detailed action rules. Likewise, the atomic instructions of a detailed action rule may be modified so that it and/or its associated rule set provides different atomic instructions to a same or new associated XML policy rule. Therefore, a software developer has a high degree of control over interface event/AMF component modification and can control the granularity of such modifications by modifying either, or both, the XML policy rules and the detailed action rules.

Still referring to FIG. 5, operation of an AMF component, such as the Communications AMF component 50, with respect to its modification of an intercepted interface event based on the XML and detailed action rules will be more specifically discussed. The policy engine 74 responds to a stream of external stimuli of various kinds from various sources and received as interface events across interfaces to which the policy engine 74 is in communication, such as one or more of the AFM APIs 22a-22e for the software components 40, 42, the interface 32 for policy rule access and component based Application Middleware Framework management functions, and the inter-AMF component interface 71. The external stimuli may include requests for service from applications or other AMF components, management requests and/or stimuli from event policy matching. Each interface event includes an event type plus additional information describing the event.

For example, an application service request interface event may include: a unique event type identifier for application service requests; a unique identifier for the service being requested; service request arguments; the identity and address of the requester together with the requestor's security credentials; the identity of the subscriber for whom the request is made, including subscriber credentials; and relevant context information such as, for example, the status of the request, e.g., initial, repeat request, terminate. Other types of interface events will also include the appropriate event type identifier plus additional descriptive information, with the specific information varying based on the event type. Other candidate interface event types to which the above-discussed rule sets may be matched by the parser 76 may include: management requests; application callbacks; management callback; environmental events; and scheduled events.

The policy engine 74 applies policy rules to an interface event intercepted by the interceptor 70 to determine a response. These policy rules are organized into rule sets, each of which contains rules relevant to a particular type of interface event or context, and each of which is associated with a corresponding type of interface event. For example, when an interface event of type T is received, the XML parser 76 matches the interface event with the XML rule set corresponding to T at the CIM 48 and a corresponding detailed action rule set at the detailed action rules database 78, and informs the policy engine 74 of the event match. The policy engine 74 then applies the XML and detailed action rules sets corresponding to T to the interface event to determine the appropriate action(s) for the adaptor 72 to take based upon the information content of the interface event. The adaptor 72 then takes the appropriate action(s) as discussed above and instructs the interceptor 70 as to what response to send back to the AMF component 50.

It should be noted that, prior to application of the rule set corresponding to the interface event of type T, other rule sets may also be applied to the interface event to handle decisions having to do with aspects of the interface event that are independent of the event type and that are at a higher level of abstraction. One example of such an aspect is application of business rules, such as requirements for authentication of the requesting software component, requirements for negating all requests from a specific software component source regardless of event type, and the like. Rules in rule sets may specify additional rule sets to be invoked to analyze interface events and to determine appropriate behavior. This additional rule set feature provides the opportunity for behavior sharing and reuse among interface event types and also provides a mechanism by which a first level rule set may be used to determine which of several alternative second level rule sets is relevant to a particular interface event. Use of additional rule sets may be used to select relevant business rules, as well as to choose the rule set appropriate for interface events of type T as described above. For example, application component validation in connection with a service request type interface event are examples of shared behavior factored into a separate, shared rule set.

In addition, rule sets applicable to different contexts or at different levels of abstraction may differ in the interface event information that may be referenced in conditions, and the atomic actions included in action sequences. Additionally, it may be appropriate to provide different tools to support creation and maintenance of different kinds of rule sets such as, for example, end user policy preferences, application developer preferences, service provider policies, and the like.

Each of the above discussed XML and detailed action rules consist of a condition and an action sequence. A rule is applied to an event, which consists of an event type plus additional descriptive information. A rule condition is an encoding of a Boolean function of the contents of an event; i.e., the condition evaluates to true or false for a particular event. If a rule condition evaluates to true for an event, it “fires” and its action sequence, which consists of one or more atomic actions, is executed. As discussed above, the atomic actions are stored in the detailed action rules database 78 and are defined and realized either internally within or externally from the policy engine 74.

The policy engine 74 provides additional atomic actions internally, including invoking a rule set (presumably different from the one currently active), and updating the contents of an interface event, presumably to affect decisions by other rules. There may be restrictions on updating the contents of an interface event. For example, information provided externally to the policy engine 74 may be protected from overwriting.

FIG. 6 illustrates an exemplary physical environment 80, which is a wireless communications network, in which the component based Application Middleware Framework 20 of the present invention may be deployed. More specifically: the Communications AMF component 50 may be deployed in core network servers 82; the Coordination AMF component 52 may be deployed in network feature servers 84; the Security AMF component 54 may be deployed in an application server 86; the Information AMF component 60 may be stored in data servers 88 and deployed in a data business logic server 89; the Policy AMF component 58 may be deployed in a user business logic server 90; and a web services AMF component 58 may be deployed in web servers 92. Each of the above servers is linked, either directly or indirectly, to end users, indicated generally at 94, through a network routing transport 96 as is well known in the art. Therefore, it should be appreciated that the Application Middleware Framework 20 consists of a set of AMF components, all of which offer specific services to applications, and which can be configured on a distributed computer network with supporting distributed software component middleware. Each physical node can then be dimensioned for the load for specific AMF components contained therein and any other software resources.

While the above description is of the preferred embodiment of the present invention, it should be appreciated that the invention may be modified, altered, or varied without deviating from the scope and fair meaning of the following claims.

For example, a distributed server system could be structured where each server is configured with the full complement of AMF components to reduce the inter server communication requirements due to the distributed nature of the AMF middleware system.

What is claimed is:

1. An Application Middleware Framework, comprising:
a plurality of Application Programming Interfaces (APIs) for enabling a software application to communicate with system resources through a transmitted interface event; and
a plurality of Application Middleware Framework (AMF) components each offering services to applications and associated with one or more of the plurality of APIs, wherein an AMF component includes;
a unique set of associated services offered to the applications;
an AMF component API for providing access to the associated services;
an interceptor for intercepting the transmitted interface event;
a rules database for storing AMF component service modifying rules;
an adaptor for modifying a service offered by the AMF component based on the AMF component service modifying rules stored in the rules database; and
a policy engine for attempting to match the interface event with the AMF component service modifying rules stored in the rules database, and for subsequently coordinating the modifying of the service of the AMF component by the adaptor when the interface event is matched with at least one of the AMF component service modifying rules stored in the rules database.

2. The Application Middleware Framework of claim 1, wherein the interceptor is further for indicating to the AMF component that the service of the AMF component has been modified by the adaptor; and the policy engine is further for coordinating the indicating to the AMF component by the interceptor that the service of the AMF component has been modified by the adaptor.

3. The Application Middleware Framework of claim 1, wherein the rules database comprises a semantic format rules database for storing AMF component service modifying rules.

4. The Application Middleware Framework of claim 3, further comprising a parser located between the semantic format rules database and the policy engine for parsing the semantic format AMF component service modifying rules stored in the semantic format rules database to match the interface event with the AMF component service modifying rules stored in the semantic format rules database for the policy engine.

5. The Application Middleware Framework of claim 4, wherein the parser is further for providing information to the policy engine on what action to take after the parser parses the semantic format AMF component service modifying rules stored in the semantic format rules database.

6. The Application Middleware Framework of claim 4, further comprising a detailed action rules database linked to both the semantic format parser and the policy engine for storing detailed action rules that further define the semantic format AMF component service modifying rules.

7. The Application Middleware Framework of claim 6, wherein the parser is further for informing the policy engine on what action to take after the parser matches the interface event with one or more of the semantic format AMF component service modifying rules stored in the semantic format rules database, and the semantic format AMF component service modifying rules stored in the semantic format rules database with the detailed action rules stored in the detailed action rules database.

8. The Application Middleware Framework of claim 6, wherein the detailed action rules define specific atomic actions to be taken by the adaptor and the interceptor in connection with the semantic format AMF component service modifying rules parsed by the parser.

9. The Application Middleware Framework of claim 8, wherein the semantic format rules database is reconfigurable to modify the detailed action rules and therefore the interface event.

10. The Application Middleware Framework of claim 8, wherein the detailed action rules database is reconfigurable to modify the semantic format rules and therefore the interface event.

11. The Application Middleware Framework of claim 6, wherein the detailed action rules database is externally located in the each of the AMF components.

12. The Application Middleware Framework of claim 6, wherein the detailed action rules database is located within the each of the AMF components.

13. The Application Middleware Framework of claim 3, wherein the semantic format rules database is located in a directory mediated by a common information model.

14. The Application Middleware Framework of claim 3, wherein the AMF component includes an inter-AMF interface for enabling the AMF component to communicate with others of the plurality of AMF components.

15. The Application Middleware Framework of claim 14, wherein the AMF component is dependent on functionality of one or more of the plurality of AMF components in communication with the AMF component through the inter-AMF component interface.

16. The Application Middleware Framework of claim 14, wherein the AMF component comprises one of the following:
an AMF Communications component for providing services required for the software application to access the system resources through one or more of the plurality of APIs;
an AMF Coordination component for providing services that coordinate behavior of the plurality of AMF components to ensure compliance with framework specifications;
a AMF Security component for providing a set of security services to the software application, others of the plurality of AMF components and to framework users;
an AMF Web Services component for providing services that enable World Wide Web access and access to related services;
an AMF Policy component for providing services that enable services of others of the plurality of AMF components to be controlled as the others of the plurality of AMF components react to interface events;
an AMF Information component for providing services that enable access and management of data, profiles, and any other stored application support information; and
a AMF Management component for providing all necessary management services to deploy, provision, operate, administer and maintain the application and the programmable Application Middleware Framework.

17. The Application Middleware Framework of claim 1, wherein each of the plurality of AMF components is extensible.

18. A method of modifying Application Middleware Framework (AMF) component services in a programmable Application Middleware Framework, comprising:
intercepting an interface event being transmitted from a software application to a software component;
attempting to match the interface event with stored AMF component service modifying rules; and
modifying a service of an AMF component correlated with the interface event based on the stored AMF component service modifying rules if the attempting to match the interface event with stored AMF component service modifying rules results in a match.

19. The method of claim 18, wherein the attempting to match the interface event with stored AMF component service modifying rules comprises:
parsing semantic format AMF component service modifying rules in attempting to match the interface event with stored AMF component service modifying rules; and
if the parsing of semantic format AMF component service modifying rules in attempting to match the interface event with stored AMF component service modifying rules results in the match, correlating a matched semantic format AMF component service modifying rule with one or more detailed action rules that further define the matched semantic format AMF component service modifying rule.

20. The method of claim 18, further comprising:
further modifying the interface event with a second set of stored AMF component service modifying rules subsequent to the modifying of the interface event based on stored AMF component service modifying rules if the attempting to match the interface event with stored AMF component service modifying rules results in a match.
